(19) United States
(12) Patent Application Publication
(10) Pub. No.: US 2007/0042336 A1
(43) Pub. Date: Feb. 22, 2007

(54) Backwards and backwards numbering system

(75) Inventor: Paul Mokonya Eko, Cleveland, OH (US)

Correspondence Address: PAUL MOKONYA EKO, 7561 Pearl Road, Cleveland, OH, 44130, US

(73) Assignee: ROSE DOH, Cleveland, OH (US)

(21) Appl. No.: 11/205,353

(22) Filed: Aug. 17, 2005

(51) Int. Cl. G09B 7/00

(52) U.S. Cl. 434/362

(57) ABSTRACT

A sequentially backwards numbering method in a story book to easily and exactly configure how many pages are left to be read in the story. This system reverses the page numbers so that the highest number of the page count becomes the first number of the first page of the first chapter while the lowest number of the page count becomes the last number of the last story line page in the last chapter. At any given time, the reader will know the number of pages left to be read because each sequentially declining number denotes the number of pages left to finish reading the book.

### BACKGROUND OF THE INVENTION

1. Field of the Invention

The present invention pertains to a precise mathematical formula of numbering story line books to aid the reader of a story book to easily know how many pages are left to be read, how many pages have been read, and how many pages constitute the total number of pages in the book.

2. Description of Related Art

The process of numbering any book today involves starting the numbering system with the lowest number of the page count at the beginning of the first chapter or sub page before the first chapter and ending the numbering with the highest number of the page count at the end of the book as the reader reads from left to right sequentially. This conventional way of numbering books is hereby called Traditional Numbering System (TNS).

At present, there is no distinction in book numbering between a reference book in which there is no desire for the reader to know how many pages are left to be read and a story line book such as a novel in which the reader often wants to know how many pages are left to complete the book. Besides, in a reference book, such as a classroom textbook (history book), the reading is not necessarily done on a sequential basis. The reader can “bounce” to reference the content for proper comprehension from chapter to chapter in a reference book. This trend is completely opposite to a story line style of reading such as a novel in which there is a sequential continuity of thought, numbering, and reading in order to properly follow the story line plot in the book.

Presently, there is no book numbering system that invokes a backwards numbering system to denote the number of pages left to be read. The only piece of related art with a backwards numbering system is a calendar. Calendars have the habitual form of denoting the present day of the month in that year plus a backwards days numbering system that counts the number of days left to the end of the year or Christmas as of January 1 st every year.

Readers of story line books such as a novel are left with nothing but bad mannerisms of fumbling with the last page number which they flip back and forth to look up and figure out how many pages are left to complete a story and thus test their convolutional math which they can't stand. They often subtract their TNS component on the page from the last page number. The present invention deals with this problem by providing a system that tracks, calculates, and displays the total number of page count, the number of pages read, and the number of pages left to be read.

### SUMMARY OF THE INVENTION

This invention involves a sequentially backwards book numbering system that keeps track of the number of pages left for the reader to finish reading a story line book.

This backwards numbering system is also enhanced by a forward numbering system that lets the reader know how many pages have been read as the reader balances the pages read and the pages left to be read.

And, the invention embodies the number of pages to be read and the number of pages already read in a Total Number of Page System on each page. Thus, the resulting Total Number of Page System (TNP) of each page is arrived at by adding the forward and backwards numbers of each page to give the reader the TNP.

Uniquely ingrained in the forward numbering system is an Exclusive Numbering Interger of (b−1) where (b) stands for a page number of the traditional numbering system. Thus, the first number of the forward numbering system is going to be (1−1) or 0 to denote the beginning of the book. And, the last number of the book is going to be (E−1) where E is the traditional last page number.

At any given time, the reader can tell how many pages have been read, how many pages are still left to be read, and what the total number of pages are. These are all embodied and displayed on each page of the book as the reader reads along.

And, the invention also performs well on reference books if they are numbered on a stop and go basis by chapters or subject matter. Stop and go means the pages are started and renumbered individually by the total chapter count because the researcher or reader of a reference book is not interested in the number of pages left to be read in order to complete the research.

Besides, reference books lack continuity except with a subject matter or chapter. And, by “reference books”, we denote any other publication that is not a story with a continuity comprising of a beginning and an end.

### BRIEF DESCRIPTION OF THE DRAWINGS

FIG. 1 is the first page of the first chapter using the traditional first page numbering system with only one number on the page beginning with page 1.

FIG. 2 is the last page of the last chapter of the book using a traditional last page numbering system with sequentially forward numbering.

FIG. 3 is the first page of the backwards numbering system of the first chapter in the invention.

FIG. 4 is the last page of the backwards numbering system of the last chapter in the invention.

FIG. 5 shows the ENI, TNP, BNS, and the FNS.

FIG. 6a displays TNP, FNS, BNS.

FIG. 6b shows the Complimentary Numbering System and the Virtual Numbering System that reside on each page.

FIG. 7 shows previous pages, number in progress page, and next pages to be read.

FIG. 8 illustrates the forward numbering system as it relates to the backwards numbering system in an X and Y axis.

FIG. 9 denotes the tinting of TNP and FNS to limit reader distraction from the main BNS.

FIG. 10 shows the possible vertical and horizontal orientations of the various numbering systems.

FIG. 11 illustrates the various “display formats”.

FIG. 12 shows another display format.

FIG. 13 portrays the reader's delusional perception of the various numbering systems

### DETAILED DESCRIPTION OF THE INVENTION

The following are definitions, formulas, equations, and settings that properly describe and demonstrate the proper use of this invention:

1) Page Definitions

a) Total Number Pages (TNP) . . . number of pages in a book.

b) Highest Page Count (HPC) . . . highest page count in the book

c) Highest First Number (HFN) . . . first number in a backwards numbering system derived from the HPC

d) Lowest Page Count (LPC) . . . lowest page count in a book

e) Lowest Last Number (LLN) . . . this is the lowest page count (LPC) of the book and is usually page one (1)

f) Number Pages Read (NPR) . . . number of pages the reader has finished

g) Number Pages Left (NPL) . . . number of pages reader has left to read in book

h) Number In Progress (NIP) . . . page reader is currently reading. This page is unread otherwise reader will not be on it.

i) Exclusive Numbering Interger (ENI) . . . patch or adjustment to the traditional numbering system in a forward numbering system (FNS) that compliments the backwards numbering system (BNS) in this invention to the total numbering system (TNP)

j) Left To Right (LTR) . . . the direction a reader reads through when reading a story line or reference book

2) Book Numbering Systems

There are 6 numbering systems in this invention. These systems are defined, coded, and schemed as follows:

| DESCRIPTION | | CODE | METHODOLOGY |
|---|---|---|---|
| 1) | Traditional Numbering System | TNS | Traditional |
| 2) | Backwards Numbering System | BNS | Invention |
| 3) | Forward Numbering System | FNS | Invention |
| 4) | Total Number Page System | TNP | Invention |
| 5) | Complimentary Numbering System | CNS | Invention |
| 6) | Virtual Numbering System | VNS | Invention |

There is no mathematical difference in the following numbering systems: CNS, TNP, and VNS. These are explained in detail:

TNP denotes the total number of pages in the book and is printed on each page of the book as a point of reference. It has no resulting formulation. It is hereby called an “image” number or a “display” count. It is a self-contained set of components in its own total despite the repetitious appearance of the number on each page. Its components are itself

CNS denotes the resulting formulation of adding the individual components of each forward numbering system(NPR) to the individual component of the backwards numbering system(NPL) to get an output called Complimentary Numbering System. This numbering system on each page is a “formulation” or “product” measured as follows: CNS=FNS+BNS or TNP=NPR+NPL.

VNS denotes the mental confirmation system the readers performs in adding the forward and backwards numbers on each page in these respective systems to generate a total page number called VNS. The reader may actually subtract the forward page number in the forward numbering system on a page from the total number of page and see if it equals the backwards number on the page. This mental numbering system is called a virtual numbering system (VNS). It is performed occasionally by the reader as a test of reassurance that the printed numbers (TNP, CNS, FNS, & BNS) are all properly computed and printed in the book. VNS is not a displayed number on the page in the book. It is displayed in the reader's mind

3) Numbering Systems Orientation

The numbering systems in this invention have two possible orientations . . . vertical or horizontal. Vertical Orientation(VO) relates to the page to page flipping mechanism which is required for the numbering system to sustain its continuity. This contrasts with a Horizontal Orientation(HO) where no page flipping is required because the numbering system is completely functional on each individual page by itself or on its own merit without the need of other pages. Vertical orientation requires page stepping through flipping from north to south or vice versa across several pages to maintain its continuity while the horizontal orientation is self-contained in each page and flows from east to west or vice versa.

The following orientations are assigned to the various numbering systems:

| SYSTEM DESCRIPTION | | CODE | ORIENTATION |
|---|---|---|---|
| 1) | Traditional Numbering System | TNS | Vertical |
| 2) | Backwards Numbering System | BNS | Vertical |
| 3) | Forward Numbering System | FNS | Vertical |
| 4) | Total Number Page System | TNP | Both (V & H) |
| 5) | Complimentary Numbering System | CNS | Horizontal |
| 6) | Virtual Numbering System | VNS | Horizontal |

4) Formulas

A) Page Specific Formulas
a) TNP=HFN=TPC
b) TNP=NPR+NPL
c) TNP−NPR=NPL
d) TNP−NPL=NPR
e) CNS=FNS+BNS

B) Number In Progress (NIP)
a) NIP=NPL
b) NIP can not be “a completed page or NPR”
c) There is only ONE NIP at any given time in a book

Number In Progress is the page the reader is reading currently or is also called the “bookmark page”.

C) Conversion Formulas
a) TNS to FNS . . . FNS=TNS−1
b) FNS to TNS . . . TNS=FNS+1
c) TNS to BNS . . . BNS=TNP−(FNS−1)
d) BNS to TNS . . . TNS=TNP−(BNS−1)
e) FNS to BNS . . . BNS=TNP−FNS
f) BNS to FNS . . . FNS=TNP−BNS
   5) Environmental Setting For a Story Book

An environmental setting in a book requiring:
A Story line book to have content with a beginning, a continuity, and an ending;
B. Book is bound along the spine so that each leaflet of the book comprises of two pages made up of a front and back page of a continuous count in the story line of the printed content;
C. Book is read from left to right or right to left, sequentially, to maintain story line and content flow;
D. Book pages have markings denoting the following possible protocols:
   1) Cover, title, author, publisher, copyrights, publication date, table of content, introduction, comments, reviews, ISBN, etc;
   2) Chapter(s), title(s), subtitle(s), byline(s), and author(s);
   3) Ornament(s) such as lines under, lines above, or beside titles, drawings, and text;
   4) Page number(s) to gauge plot flow, indulgence, and pages read.

### DETAILED DESCRIPTION OF THE ILLUSTRATED EMBODIMENTS

In this invention, the first priority is to setup an example to demonstrate the functions and properties of the various aspects of the invention. We are going to setup a test sample for a novel with a 297 total page count or Total Number of Pages System (TNP).

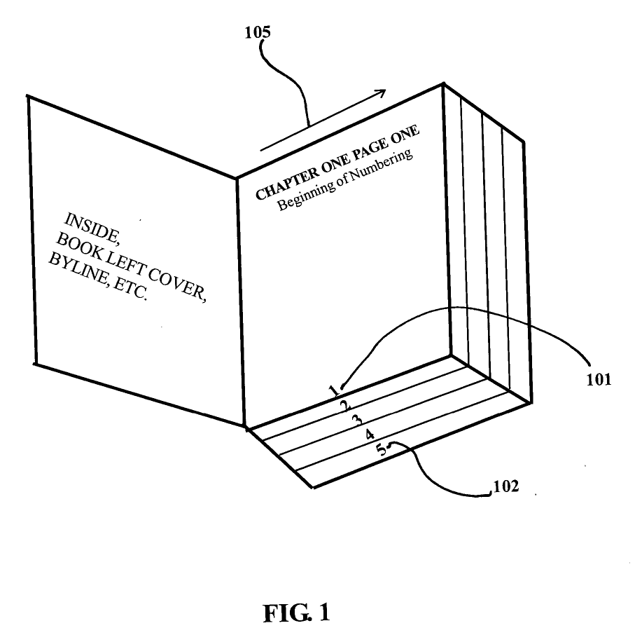

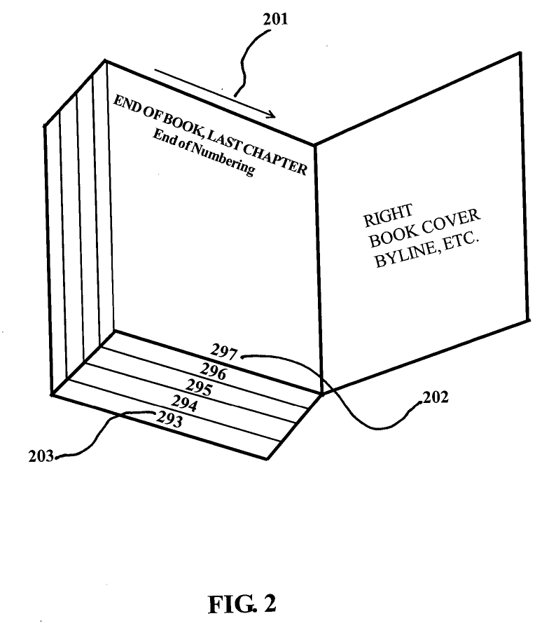

FIG. 1 is an illustration of the first page number in a Traditional Numbering System (TNS). The numbering system begins with 101, steps up to 102 and sequentially ends with 297 in 202 in FIG. 2. The reading of the book is from Left To Right (LTR) as in 105 in FIG. 1 and 201 in FIG. 2.

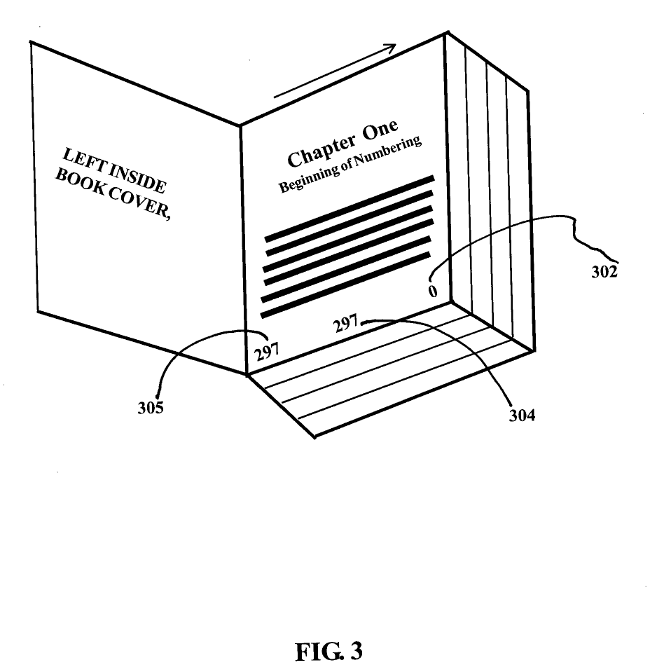

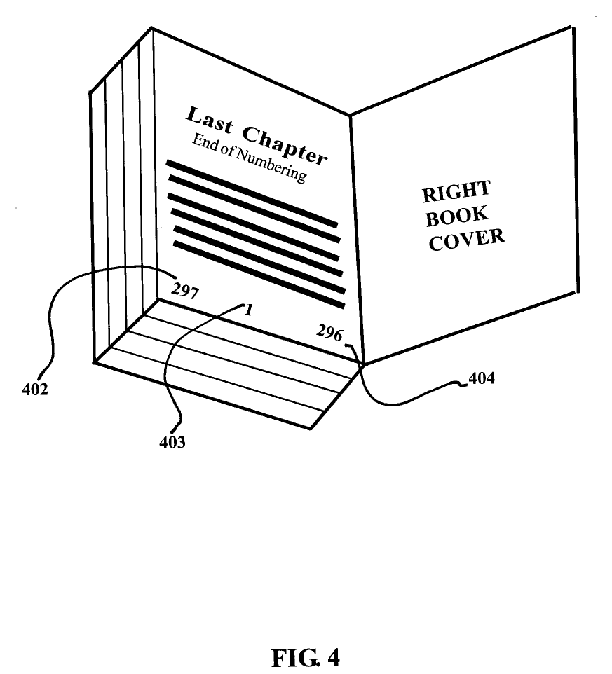

In FIG. 3 and FIG. 4, the Backwards Numbering System (BNS) invention is introduced with 304. The TNP of 297 is also assigned as Highest First Number (HFN) while the Lowest Page Count (LPC) of 1 is assigned as Lowest Last Number (LLN) in 403 of FIG. 4 as the book reads LTR, sequentially.

In FIG. 3 and 4 displays and the rest of the pages in the book, the TNP is displayed alongside the BNS. In our case, the TNP value is 297 as in item 305 and 402. This TNP value is constant and is displayed on every page of the invention. The TNP value is considered self-contained as an “image” or “display” because it is a set of components in its own make of static numbers that have the same value of 297. But, the system steps from page to page and thus forms this unique numbering system vertically.

FIG. 3 and FIG. 4 also mark the beginning and continuation of the Forward Numbering System (FNS). The FNS as in 302 starts with a zero (0) because the reader has not read the first page. Thus, the first page can not be numbered Page One (1). Besides, if this FNS were numbered with a (1) as in 101 in FIG. 1, then two problems would emerge: the reader can not call the first page as complete when the reader is still reading it and the related page numbers on that page will not add up to the total number of pages.

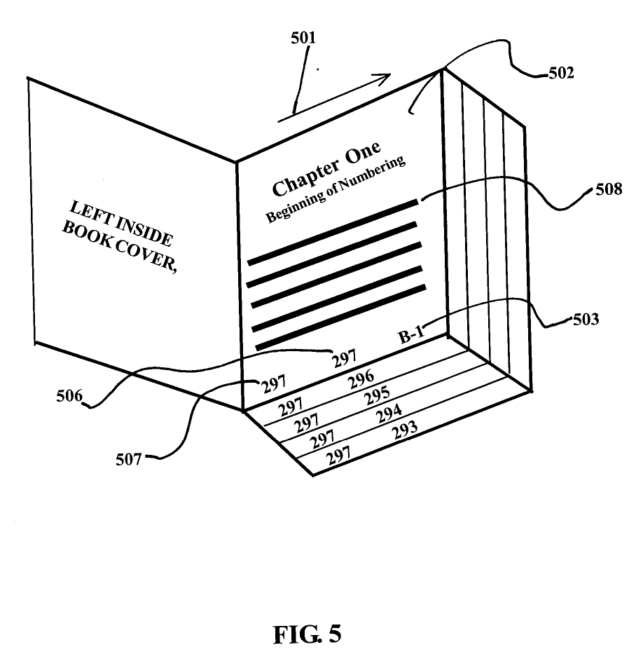

FIG. 5 is the beginning of the invention's numbering system. This is the first page of Chapter One in which the numbering system begins as in 502. The text in the book is shown in 508 while the numbering systems are displayed in three set of numbers that have an interactive relationship among them to denote total pages as in 507, read pages as in 503, and pages left to read as in 506.

An Exclusive Numbering Interger (ENI) as in FIG. 5 Item 503 mathematically explains the exclusion of the page that the reader is currently reading. This formula of (B−1) means that the current page being read can not be counted as “completed” or “finished” by the reader. Thus, at any given point or page in the book, the FNS can be configured from the individual value of a TNS by using the ENI adjustment of subtracting (1) from the TNS value to get the FNS value of the invention.

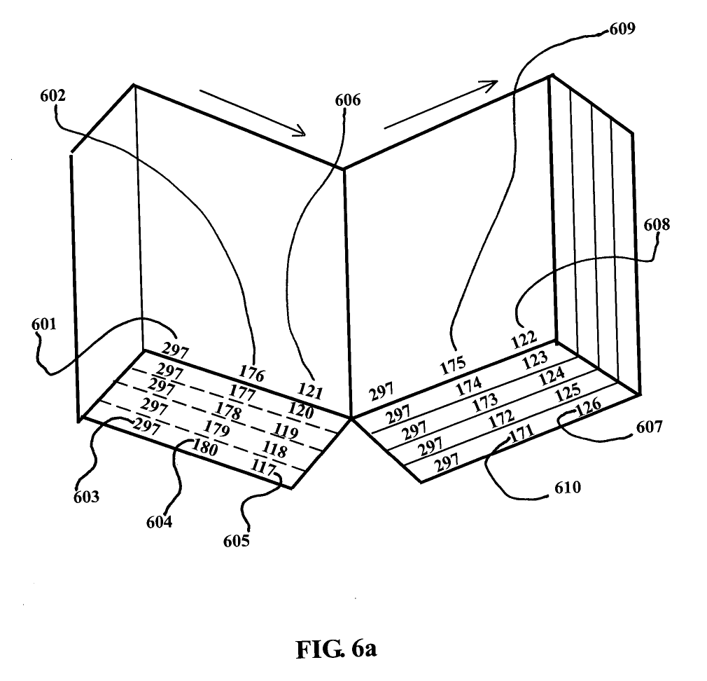

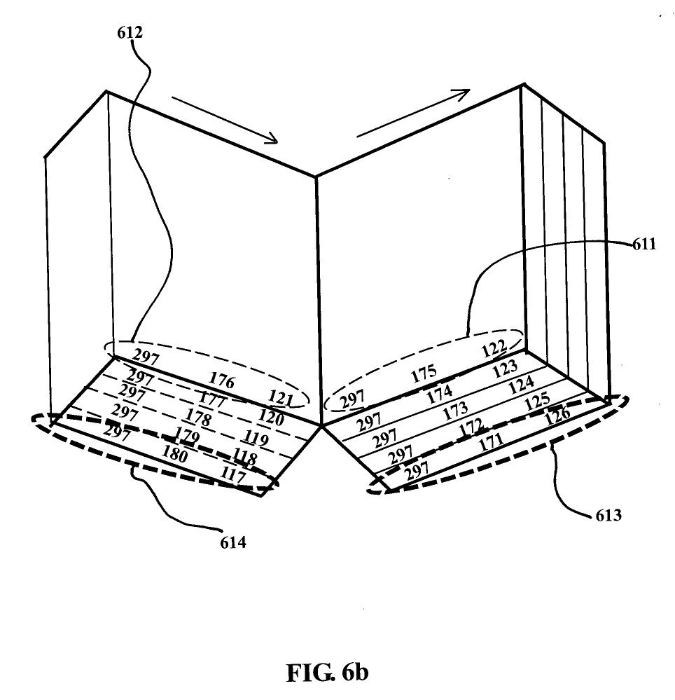

As always, an LTR 501 is in effect throughout the book. As of FIG. 5, we have a complete set of numbering systems for the invention: TNS, TNP, BNS, and FNS. In 101, 102, 203, and 202 we have a traditional numbering system (TNS). In FIG. 6a. 604 to 602, 609 to 610, and up to 403, in FIG. 4 we have a BNS denoting the number of pages left to be read or NPL. For the FNS denoting the number of pages completed, 605 to 606, 608 to 607 and 404 so indicate the system to the reader. In FIG. 6b, the CNS system is displayed in the form of 611 and 613. In the same FIG. 6b, the VNS system that the reader occasional performs is displayed in 612 and 614.

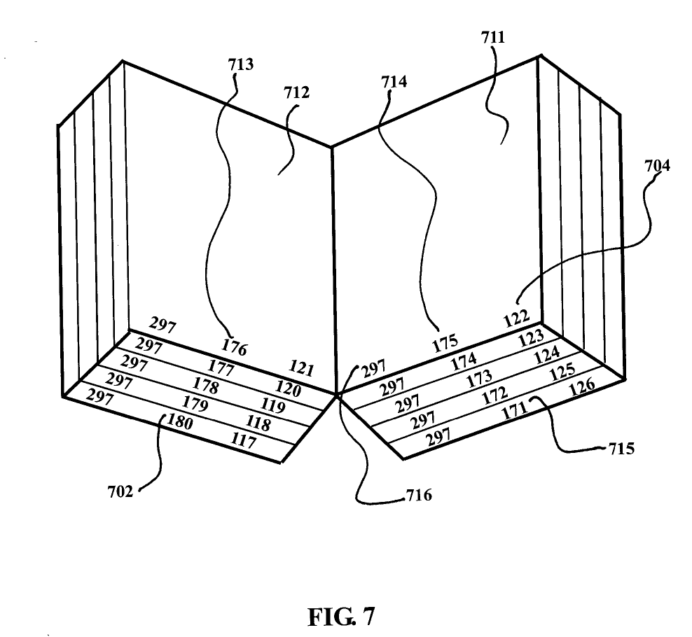

At any given point when the reader is reading, a break or an intermission may be taken. This means that the reader is going to bookmark a page. This page is also called the “current” page. In our case with a BNS in effect, the reader is going to stop on FIG. 7 Item 711 in what the invention terms Number In Progress (NIP). Any page can be an NIP. This is the example we are working with. In 712 using the BNS, we have a set of previous pages as follows: 702 to 713 denoting pages 180 through 176 while in 711, we have pages left to be read or “forthcoming” pages as follows: 714 to 715 denoting pages 175 to 171.

In 704 taken from a horizontal perspective, a Complimentary Numbering System (CNS) is derived. CNS denotes the resulting formulation of adding the individual components of each forward numbering system as in 704 to the individual component of the backward numbering system as in 714 to get an output called Complimentary Numbering System as in 716. This numbering system on each page is a “formulation” or “product” measured as follows: CNS=FNS+BNS. It is derived at by a calculation as contrasted to the TNP indicated by an image number as in 716.

FIG. 7 shows pages 176 and 175 of the Backwards Numbering System. The sequential descent goes on until the lowest page count number is arrived at. As a point of reference, the BNS is the most desired number of all the systems. However, the last of the numbering systems in this invention comes into place when the reader mentally reconfirms the relationship between TNP, BNS, and the FNS. In our example, the reader would mentally subtract 704 from 716 and see if the answer is going to be 714. This mental torture for self assurance is termed in the invention as the Virtual Numbering System (VNS).

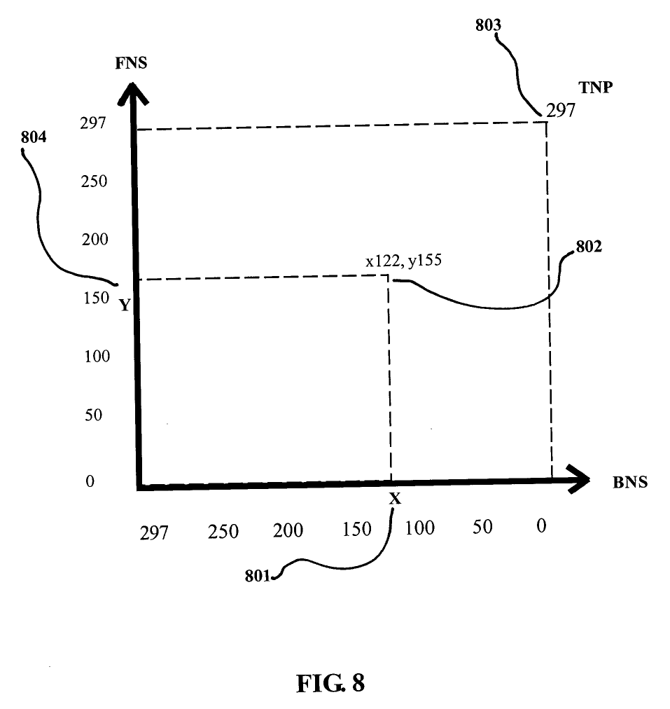

In FIG. 8, the relationship between FNS and BNS is displayed. This relationship is inversely proportional. The more pages that are left to be read, the less pages that have been read. Put in an X and Y axis in this illustration, the reader is on page 122 for pages left to read as in 801 of a BNS while the reader has finished 155 pages as in 804 of an FNS. Of course, the TNP on either system is 803 and the finished and unread pages intersect at 802.

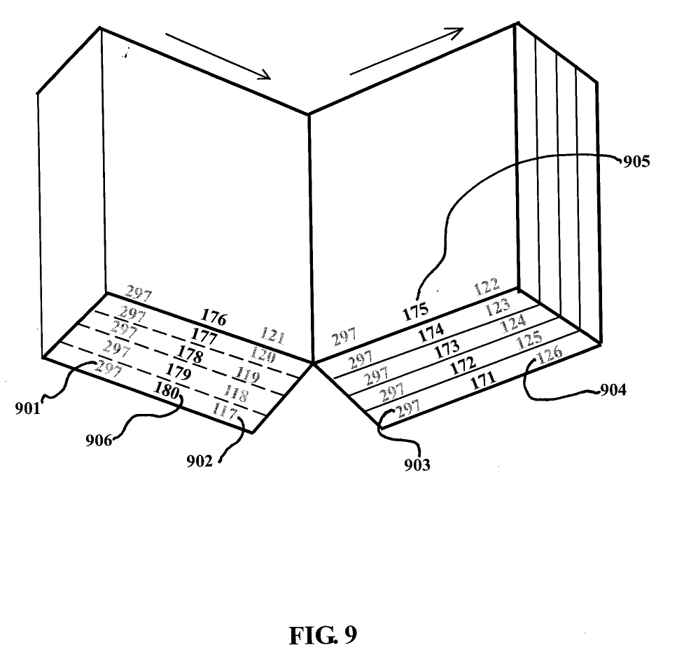

The display of too many numbers on each book page, in addition to the book byline of the title or author, may create an illusion of “crowding” or “distracting” problems. FIG. 9 attempts to resolve these illusions and distractions by tinting or reducing the size of the numbers. To reduce the human intuition of being distracted and feeling claustrophobic, the Total Number of Page System (TNP) as in 901 and 903 together with the Forward Numbering System (FNS) as in 902 and 904 are tinted or screened between 5% to 25% while the Backwards Numbering System (BNS) as in 906 and 905 is left intact at 100% solid text. In effect, the TNP and the FNS are “by products” of the BNS which should take center stage while the tinted numbers are captured by the reader's subconscious mind. At any given time, if the reader makes an extra effort to read the tainted numbers, they will be there for the picking. But, the reader has to make an “extra effort” because the numbers are diminished in status either by size or tint. FIG. 9 shows a tinted option. But, the smaller size type option is also claimed in this invention but not illustrated due to redundancy.

The invention takes on a distinctively unique scheme of characterizing each of the six numbering systems as either having a vertical or a horizontal orientation. A vertical orientation is an orientation that goes from south to north or vice versa. A horizontal orientation is one that goes from east to west or vice versa. This means that all the numbers in all the pages can be looked at and read from a 3D perspective and splashed into patterns. The one distinctive pattern that emerges is the vertical and horizontal orientation.

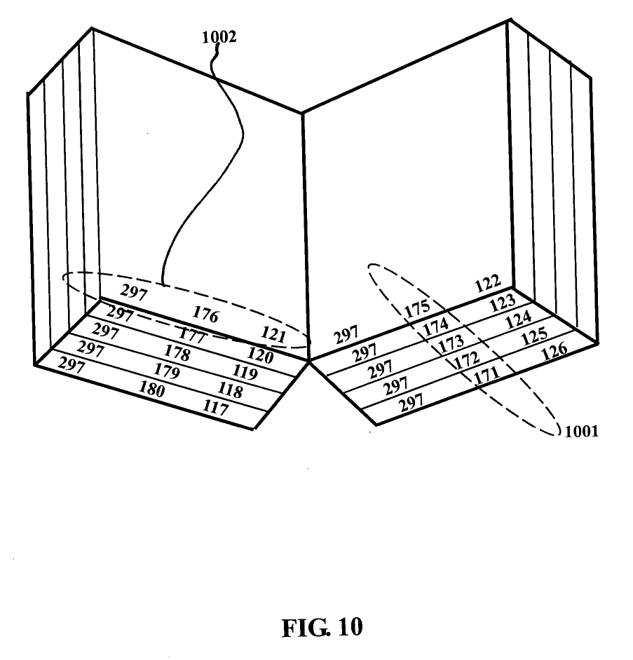

Vertical orientation as in 1001 of FIG. 10 relates to the page stepping process from page to page as the reader reads these pages or flips through them with the reader's eyes focused on the numbering system in order to gain some “completeness” in the system. As the reader flips pages, a string of numbers will be generated and this string is another signature of the invention. The string can be backwards or forward but the numbering system has to be “strung” with other numbers in different respective pages in order to maintain the “continuity” of the numbering system. It doesn't matter if the reader goes forward or backwards. However, a funny thing happens when a user flips pages and focuses on the TNP. An illusion develops as the reader wonders if the pages are actually turning at all. For, the reader has to confirm the turning of the pages by looking at BNS or FNS to reassure self that the TNP is a static number and the pages are being flipped to maintain continuity in the numbering system. In this invention, TNP, BNS, FNS, and TNS have a Vertical Orientation.

FIG. 10 item 1002 is considered a horizontal orientation in this invention's scheme of characterization. In a horizontal orientation, the numbering system is complete and self-contained on every page in the book. In this invention, the TNP, VNS, and CNS are all schemes with horizontal orientations. In this orientation, the reader does not need to flip and string the pages together in order to have the completeness of the numbering system. This completeness is self-contained in each page.

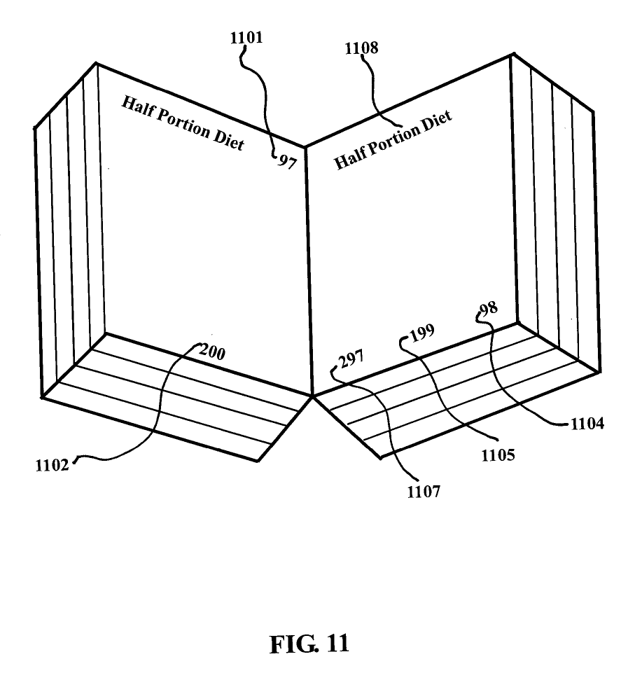

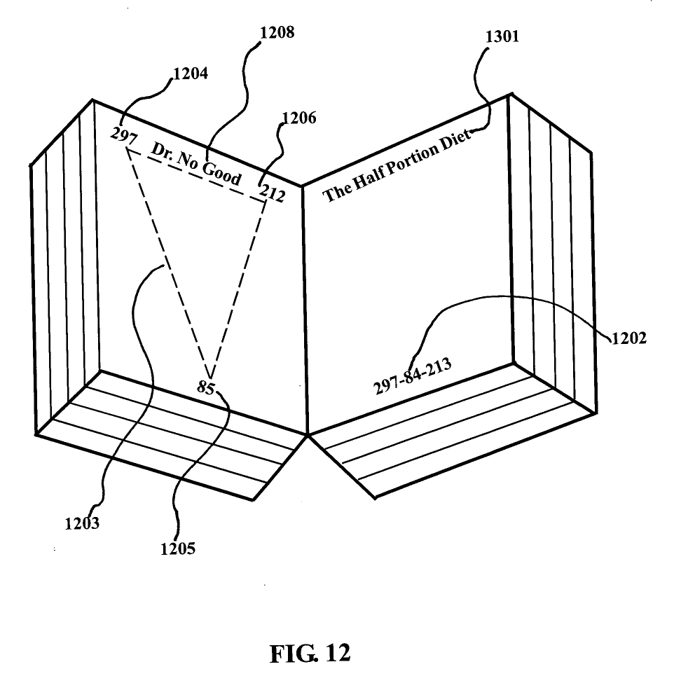

“Display Formats” as described in this invention deal with the different ways the numbering systems can be displayed and printed on the page of a book. Should the numbers be on top of the page or at the bottom of the page? Should the numbers be printed side by side with bylines of the author or title? These are all options in this invention. In FIG. 11, page 200 in a BNS, the reader is presented with a Criss Cross Duo display format (1102-1101) with a byline of the book aligned next to the top number as in 1101. In FIG. 12, page 85 in a BNS, the reader is shown a Criss Cross Trio display format (1205-1206-1204) which has a triangular effect of 1203 that is not printed but is created in the illusion. The author's byline is displayed in between as in 1208. Of course, 1204 and 1206 are tinted enough not to distract from the byline of the title or the author.

In FIG. 11 page 199 in a BNS denoted as 1105, an Edge Center Edge display format is presented (1107, 1105, 1104) with the edged numbers tinted or reduced in size to relieve the reader of distractions. The title page is 1108 and is all alone. Furthermore, on page 84, FIG. 12 in a BNS as in 1202, a Dash to Dash scheme is displayed with all the numbers bunched together and separated by dashes . . . the dashes and the side numbers are tinted or diminished in size for effect. And, the byline of the title page is on top of the page as in 1301.

The following are the final statistics in our example:
a) TPC=Total Page Count . . . 297
b) HFN=Highest First Number . . . 297
c) LLN=Lowest Last Number . . . 1
d) NPR=Number Pages Read . . . 122
e) NPL=Number Pages Left . . . 175
f) NIP=Number In Progress . . . 122
g) ENI=Exclusive Numbering Interger (b−1) for beginning . . . 0

h) TNP=Total Number Pages=Total Number of Page Numbering System . . . 297

PAGE SPECIFIC FORMULAS

| | | | |
|---|---|---|---|
| a) | TNP = HFN = TPC | becomes | 297 = 297 = 297 |
| b) | TNP = NPR + NPL | becomes | 297 = 121 + 176 |
| c) | TNP − NPR = NPL | becomes | 297 − 121 = 176 |
| d) | TNP − NPL = NPR | becomes | 297 − 176 = 121 |
| e) | FNS Last Number (FLN) | becomes | 297 − 001 = 296 |
| e) | CNS = FNS + BNS | becomes | 297 = FNS + BNS |

The invention also introduces various display systems of the numbering systems in various combinations to properly help the reader know the pages read, bylines location, and number of pages left to read. These “display formats” on the page can be personalized to the taste of the author, publisher, editor, manufacturer, or audience in question. Such “display formats” include but are not limited to the following:
a) Criss Cross Duo . . . only two of TPN, NPR or NPL are displayed on the page as desired.
b) Criss Cross Trio . . . TNP, NPR, and NPL are displayed on book in any format with all three at bottom, top, or two at top and one at bottom
c) Dash, slash and space system . . . Numbers are bunched together but separated by dashes, slashes, and or spaces
d) Criss Cross System . . . TNP, NPR, or NPL is criss-crossed on top and bottom of page in any combination
e) Edge Center Edge format . . . TNP is on left edge of page, NPL is in center, and NPR is on the right edge of page at the bottom or top
f) Sub Number System . . . TNP, NPR, or NFL is put along with chapter sub title
g) Edge to Edge Center is the preferred numbering system with the edge numbers (TNP and NPR) being toned down in intensity from 5% to 20% type darkness so as not distract reader with too many numbers while NPL in the center with a complete 100% in darkness in intensity.

In the end, the Backwards Numbering System (BNS) is the backbone of this invention that alerts the reader to the fact that the number of pages left to be read in a book are exactly the same as the number in front of the reader. Thus, the reader does not have to exercise any mathematical computations and flipping to the end of the book in order to determine how many pages are left to be read in the book. The BNS is the solution to the reader's queries.

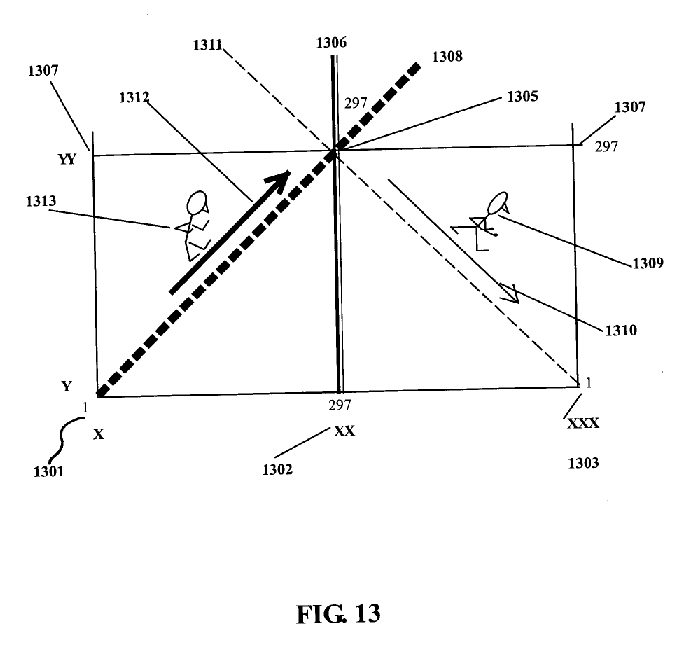

FIG. 13 shows the reader's delusion in tackling the task of reading a 297 page novel. If reader's book is numbered in a Traditional Numbering System (TNS), the reader (1313) begins reading the book from 1301 to 1302. To the 1313's perception, the reading has an “uphill agony” tone of a task in 1308 as reader develops and antagonistic feeling about this reading in 1312. Even the end result of finishing the book at XX (1302) is magnified by the reader's antibodies to the mountainous task of 1305 uphill with dark clouds raining over the reader in a 1306 shade

On the other hand, if the reader (1309) were to start the book at 1302 and head towards 1303, the backwards numbering system uplifts the reader from 1302 proper to 1305 “piece of cake world” which is a delusional feel good mode about going downhill as in 1311 with a sunny environment of 1306 that is fueled by the reader's “feel good” enzymes in 1310. Mind you, the task from 1301 to 1302 is equal to the task from 1302 to 1303. It is the same task but it is perceived differently because human “receptacles” in the brain that control “perception” if so manipulated. Forget not that these two tasks are “flat lines” but are construed to be “skewed” for bad or worse by the reader based on the numbering system presented. If FNS is used, a reader sees a skewed ascent to the end of the book while a skewed descent will be greeted with glow in a BNS.

No two human beings read the same book with the same perception. This is due to the fact that when subjective values of human nature are interjected into objectively scientific tasks, these tasks are performed differently because of the human proprietary factor that discriminates against different perceptive views and skills in performing a task. In effect, the state of the reader's mind has a deep impact on the reader's ability to read a novel within a given length of time. Whether the reader enjoys it or not is another question. This invention is meant to make it easy for the reader to carry out the task of reading with a “feel good” delusion and thus enjoy the book.

What I am claiming:

1. A numbering system comprising of a sequentially backwards numbering mechanism of a book and thus reversing the page numbers so that the highest number of the page count becomes the first number of the first page of the first chapter while the lowest number of the page count becomes the last number of the last story line page.

2. The method as identified in claim 1 further comprises of a sequentially Forward Numbering System (FNS) whereby the book's lowest page count number is at the beginning of the first page of the first chapter while the highest page count number is at the end of the last page of the last chapter to denote the number of pages read or “finished” by the reader.

3. A system as mentioned in claim 2 whereby the number in the forward numbering system (FNS) is adjusted into an Exclusive Numbering Interger (ENI) denoting the exclusion of the page being read as complete. The ENI is computed as follows: (B−1) where B is the page number in a traditional book count. In this case, the beginning number will be valued at zero (0) while the last page in the book will have an ENI as follows: (B−1) where B is the last page number in the book count.

4. The method as defined in claim 1 is also enhanced by a mechanism wherein a total number of page numbering system is implemented in which the total number of pages is displayed in conjunction with both the backwards and forward numbering systems to facilitate the relationship between pages read and pages to be read.

5. The apparatus as defined in claim 1 further includes a complimentary numbering system on every page of the book such that each page consists of a forward, backwards, and total numbering system in which the forward and backwards numbers on each page compliment (total) the total number of pages as a result of an Exclusive Numbering Interger (ENI) function. In other words, adding the individual forward and backwards numbers on each page will result in the total number of pages which is hereby termed the Complimentary Numbering System (CNS).

6. The system as described in claim 1 also encompasses a Virtual Numbering System (VNS) on each page. A VNS denotes the mental confirmation system the reader performs by adding the individual forward and backwards numbers on each page together in these respective systems to generate a total page number. The value of the VNS is equal to the Total Number of Pages System (TNP) but their means of composition is different. The reader may actually subtract the forward page number in the forward numbering system on a page from the total number of page and see if it equals the backwards number on the page. This mental numbering system is called a virtual numbering system (VNS). It is performed occasionally by the reader as a test of reassurance that the printed numbers (TNP, CNS, FNS, & BNS) are all properly computed and printed in the book. VNS is not a displayed number in a book. It is displayed in the reader's mind.

7. A numbering system as in claim 1 wherein derivative numbering systems are implemented that can take two possible orientations . . . vertical or horizontal. Vertical Orientation(VO) relates to the page to page flipping mechanism which is required for the numbering system to sustain its continuity. This contrasts with a Horizontal Orientation(HO) where no page flipping is required because the numbering system is completely functional on each individual page by itself or on its own merit without the need for pages to be turned. Vertical orientation requires page flipping while horizontal orientation is self-contained in each page and requires no page stepping.

8. The numbering system as described in claim 1 allows for the various numbering systems to be displayed in various “display formats” or “display combinations” such as backwards and forward numbers only, backwards and total only, backwards on top of page while forward and total are at bottom of page, dashes, criss-cross edge center edge, and in any desired combination within the mathematical function of these six numbering systems.

9. The method as described in claim 1 includes a formula for converting conventional story line book numbers into a backwards book numbering system as follows: add one (1) to the conventional page number and subtract this result from the total book count. This will give you the backwards page number in question. Conversely, to get from a backwards numbering system to a traditional numbering system requires adding one (1) to the backwards numbering system and subtracting this result from the total number of pages in the book to get the conventional page number or TNS.

10. The numbering system in claim 1 wherein any of the defined numbering systems in the invention such as traditional, forward, backwards, total, virtual, and complimentary numbering systems are intentionally numbered “out of sequence” in error as a contest ploy to tease the reader or carry out promotional incentives that will captivate the reader in an interactive marketing scheme to promote the book in question.

11. The numbering system as in claim 1 whereby the focus of the numbering system is the Backwards Numbering System (BNS). Thus, all other numbering systems such as “forward” and “total” are displayed in a diminutive state such as a 5% to 20% tint screen while the BNS is displayed at 100% solid format. The requirement for the BNS to be solid while the other numbering systems are diminutive is to relieve the reader of too many numbers displayed on the page so as not to distract the reader. Yet, the diminutive numbers are still visible in the reader's mind but they have to be sought after by the reader in order to be seen because of their diminished size or percentage of tint screening that makes them readily visible to the subconscious mind but not to the naked eye unless through desired focusing on the number.

12. The apparatus as described in claim 1 whereby comic books and short story books that contain multiple continuity stories including reference books are numbered backwards by chapters or subject matter with a recurrence of numbering backwards from chapter to chapter as the chapters or subject matter changes.

13. The method endorsed in claim 1 whereby all chapter numbers in the book are numbered backwards from highest chapter number to lowest chapter number.

14. The method as endorsed in claim 1 wherein a digital numbering system is an electronic environment such as a website, ebook, magazine, blog or promo is numbered backwards in a standalone computer or network system to denote the backwards numbering system (BNS) in electronic media format.

15. The numbering system as invoked in claim 1 wherein said backwards numbering system, when compared to other systems such as the forward numbering system and the traditional numbering system which both have page increments, deludes and soothes the reader's brain and sense of accomplishment in perceiving the backwards system as going “down a hill effortlessly” to accomplish a task as opposed to incremental numbers that give the reader the impression that the reader is climbing a mountain with strenuously countless obstacles on the reader's path with no end in sight. This delusion, on the part of the reader, is very helpful in motivating reader to accomplish the task of reading the book effortlessly because of the reward of being at the finish line with Number One (1) as a prize.
